(19) United States
(12) Patent Application Publication
(10) Pub. No.: US 2008/0310188 A1
(43) Pub. Date: Dec. 18, 2008

(54) Light-Bulb Conductive Device

(76) Inventor: Wen-Cheng Lai, Taoyuan (TW)

Correspondence Address: LIN & ASSOCIATES INTELLECTUAL PROPERTY, INC., P.O. BOX 2339, SARATOGA, CA, 95070-0339, US

(21) Appl. No.: 11/763,430

(22) Filed: Jun. 14, 2007

(51) Int. Cl. H01R 33/00

(52) U.S. Cl. 362/659

(57) ABSTRACT

A light bulb conductive device is provided, including a light bulb and a bulb holder. The light bulb further includes a pair of conductive needles made of hard material with a sharp tip to penetrate the plastic shell of the conductive wire to contact with the conductive metal wire to form electrical connection. The bulb holder is formed by injection molding to embed the light bulb. The light bulb conductive device of the present invention is easy to assemble, stable in use, inexpensive to manufacture, and also waterproof.

### FIELD OF THE INVENTION

The present invention generally relates to a conductive device for an illumination device, and more specifically to a conductive device applicable to a variety of illumination devices.

### BACKGROUND OF THE INVENTION

The light bulbs used in the light string to decorate holiday festivals are usually the conventional white light bulbs. This type of light bulbs usually includes a glass bulb, a bulb head, a tungsten core, and so on. In the manufacturing of the light bulbs, the glass must be heated, shaped, sealed, and followed by air expelling. The conductive wires must be peeled, soldered to the copper ends and fixed to the bulb head or other base. Finally, the aforementioned elements must be assembled. The manufacturing process is not only expensive, but prone to manufacturing errors and wastes. Furthermore, this type of light bulbs consumes a large amount of power, generates more heat, and is more dangerous, which is not suitable for prolonged use. Additional disadvantages include the lack of color variation, and short life span.

The recent adoption of LED in the light strings solves some of the above problems. The LED provides more color variation, consumes less power, and has a longer life span, which are all great improvements over the conventional products. However, in spite of the above improvements, the manufacturing process of LED light strings still includes the assembly of a large number of elements.

For the light strings with conventional light bulbs or LEDs, the electrical connection between the light sources and the wires must be accomplished by a large number of connection elements. For example, the white light bulb must be fixed to a bulb head. The wire must be cut and soldered to conductive plates. The plates are installed and fixed inside a bulb base. The bulb head is then installed into the bulb base so that the conductive wires of the light bulb in the bulb head contacts and form electrical connection with the conductive plates inside the bulb base. The LED light string uses a similar assembly structure. As each light string usually includes at least 10 light bulbs, the assembly process is labor-intensive and also expensive.

### SUMMARY OF THE INVENTION

The primary object of the present invention is to provide a light bulb conductive device that is easy to manufacture and assemble. The light bulb uses two exposed conductive needles. The conductive needles directly penetrate the plastic shell of the conductive wires and contact with the metal wires to form electrical connection to accomplish the ease of the attachment. This also reduces the number of the connection elements that is required in the conventional light strings so as to reduce the manufacturing cost and provide easy assembly.

Another object of the present invention is to provide a light bulb conductive device that is easy to manufacture and has various shapes. The light bulb is fixed to a bulb holder. The bulb holder is formed by injection molding directly on the outside of the light bulb. Therefore, the manufacture cost is low. In addition, the shape of the light holder can be easily changed by using a different molding device. Therefore, different shapes of light bulbs can be manufactured on the same light string, unlike the conventional light strings. If LEDs are used, the present invention can further provide more selections in both colors and shapes.

Yet another object of the present invention is to provide a light bulb conductive device that can be easily customized. The designer of the light string can determines the number, the location, the color and the shape of the light bulbs on a light string, and assembles the light string easily.

Yet another object of the present invention is to provide a light bulb conductive device that is easy to attach. An additional base can be added to the bottom of the bulb holder so that when the light bulb is installed on the wires, the base will strengthen the attachment to prevent the light bulbs from loosened off the wires.

To achieve the above objects, the present invention provides alight bulb conductive device, including a light bulb and a bulb holder. The bulb holder further includes a pair of conductive needles. The conductive needles are made of hard material. The tips of conductive needles are sharp so that when assembled the sharp tips of the conductive needles can penetrate the plastic shell of the conductive wires and contact with the metal conductive wires to form electrical connection. The light bulb is attached and fixed to the bulb holder.

The bottom of the bulb holder can further include a base. The base is engaged to the bottom of the bulb holder after the light bulb and conductive wires form the electrical connection so that the wires are fixed between the base and the bulb holder to prevent the light bulbs from loosened off the wires and ensures that the conductive needles and the conductive wires are in good contact.

The advantages of the present invention include that the light bulb is embedded in and tightly engaged to an injection molded bulb holder to ensure safety in plugging and unplugging. In the mean time, an additional base can be added to the bulb holder so that the present invention is applicable to different installation conditions. Also, using the sharp tips of the conductive needles to penetrate the plastic shell of the wires provides easy assembly, eliminate the use of conductive plates and reduces the manufacturing cost.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a side view of a light bulb and a bulb holder of a light bulb conductive device of the present invention;

FIG. 2 shows a top view of the structure shown in FIG. 1;

FIG. 3 shows a schematic view of the bulb holder and base of the present invention;

FIG. 4 shows a schematic view of the bulb holder of the second embodiment of the present invention;

FIG. 5 shows a schematic view of the base of the second embodiment of the present invention; and

FIG. 6 shows a side view of the bulb holder and the base of the third embodiment of the present invention.

### DETAILED DESCRIPTION OF THE PREFERRED EMBODIMENTS

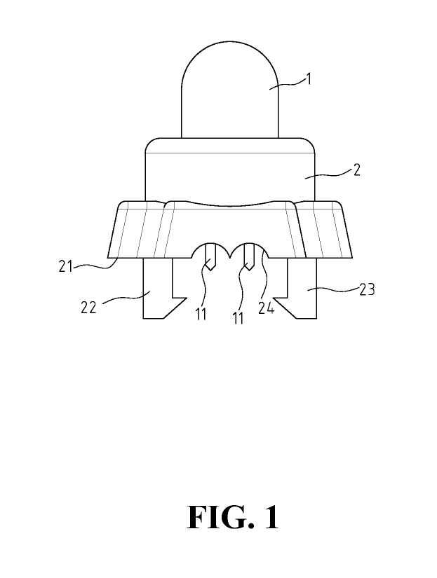

FIG. 1 shows a side view of a light bulb conductive device of the present invention, including a light bulb 1, and a bulb holder 2. Light bulb 1 of the present embodiment is an LED. Bulb holder 2 is formed by injection molding of suitable hard material, such as plastic. Light bulb 1 is embedded in the top of bulb holder 2. Light bulb 1 further includes a pair of conductive needles 11. One end of conductive needles 11 is connected to light bulb 1. The conductive needles penetrates bulb holder 2, and lower segment is exposed beyond bulb holder 2. Conductive needles 11 are made of hard conductive material. The tips of conductive needles 11 are sharp so that when assembled, the tips of conductive needles 11 can penetrate the plastic shell of conductive wires to contact the metal wires to form electrical connection. Although the present embodiment uses LED, light bulb 1 can also be a tungsten light bulb or other equivalent types of light bulbs.

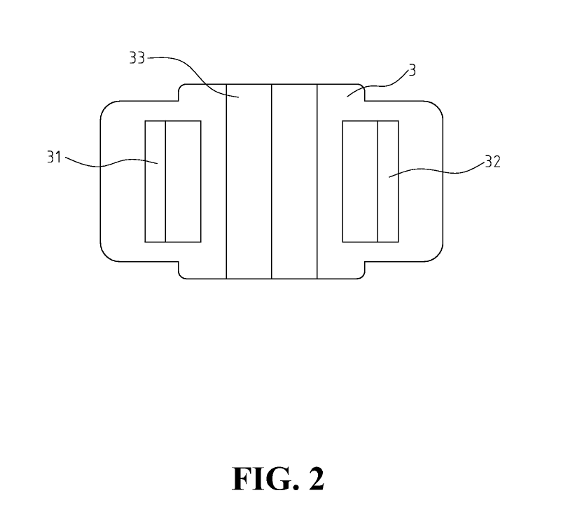

To further enhance the structure of the present invention, the present invention can further include a base 3. Base 3 can be engaged to bulb holder 2 when assembled. The shapes of base 3 are not limited to the embodiments shown in the present invention. As shown FIGS. 2 & 3, base 3 is formed by injection molding and made of a material with a suitable hardness, such as plastic. Base 3 includes a left latch socket 31, a right latch socket 32, and a base trench 33. Left latch socket 31 and right latch socket 32 are on the left side and right side of base 3, and the socket holes penetrate the entire base. Base trench 33 is a dual-hemispheric shape, located on top surface of base 3. The bottom of bulb holder 2 also has a corresponding structure. Bottom surface 21 of bulb holder 2 includes a left hook 22 and a right hook 23. The center of bottom surface 21 includes a holder trench 24, which matches base trench 33 in both shape and location. Conductive needles 11 of light bulb 11 penetrates bulb holder 2 with a small portion extending beyond and exposed in holder trench 24. The locations of left hook 22 and right hook 23 match the locations of left latch socket 31 and right latch socket 32.

When assembled, left hook 22 and right hook 23 of bulb holder 2 are inserted into and latched by left latch socket 31 and right latch socket 32, respectively. Conductive wire 4, including plastic shell 41 and metal conductive wire 42, is placed in the passage formed by base trench 33 and holder trench 24. Conductive needles 11 of light bulb 1 penetrates plastic shell 41 of conductive wire 4, and contacts with metal conductive wire 42 to form electrical connection. Thus, the good engagement and electrical connection after the assembly are achieved.

It is worth noting that the passage formed by base trench 33 and holder trench 24 is for the conductive wire to pass through. In the above embodiment, the shape of the passage is two adjacent spheres, which is to match the shape of conductive wires. However, the shape of the base trench and holder trench is not limited to the above embodiment, as long as the shape matches the shape of the conductive wire.

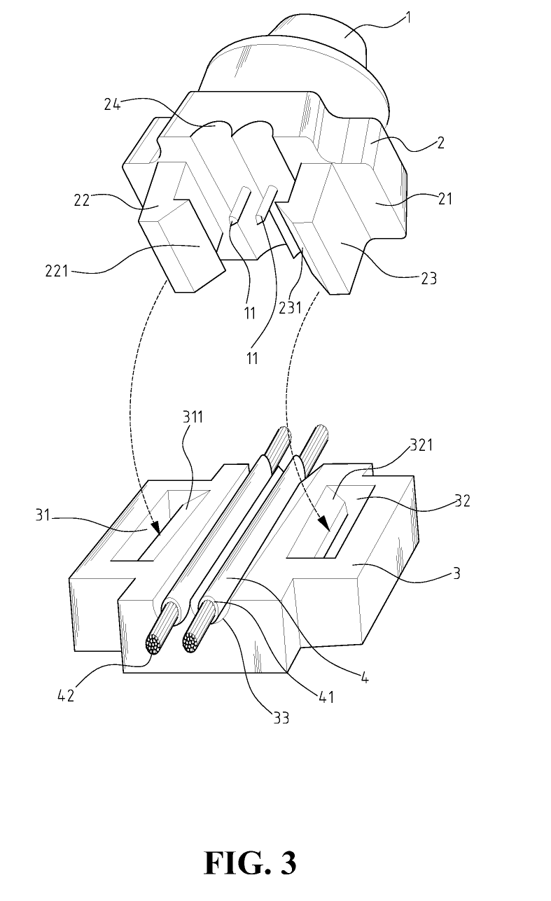

As shown in FIG. 3, left hook 22 and right hook 23 on bottom surface 21 of bulb holder 2 includes a sharp hook element 221, 231 facing inwards, respective. Therefore, corresponding guiding surface 311, 321 of left latch socket 31 and right latch socket 32 must be formed to match sharp hook elements 311, 321 to facilitate the latch.

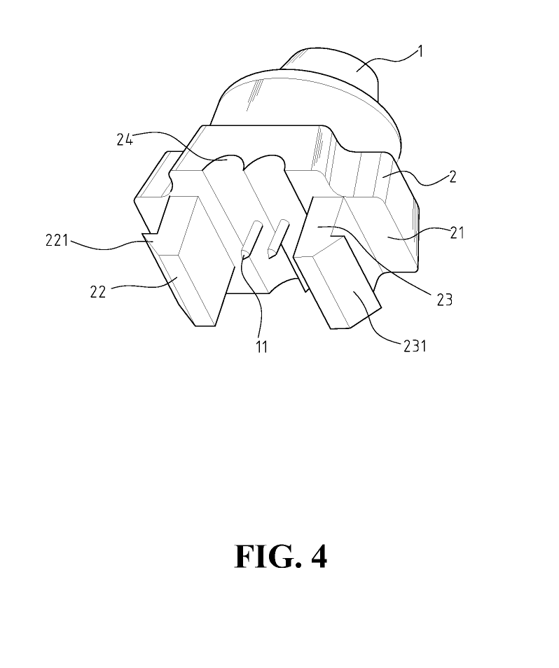

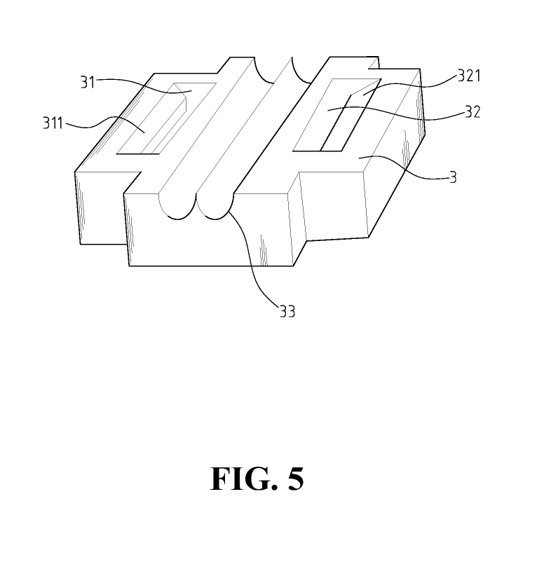

FIG. 4 shows a schematic view of a second embodiment of the bulb holder of the present invention, and FIG. 5 shows a schematic view of second embodiment of the base of the present invention. In the second embodiment, sharp hook element 221, 231 of left hook 22 and right hook 23 on bottom surface 21 of bulb holder 2 both face outwards; therefore, corresponding guiding surface 311, 321 of left latch socket 31 and right latch socket 32 must be formed accordingly to match sharp hook elements 311, 321 to facilitate the latch.

Finally, ensure the strong engagement of bulb holder 2 and base 3, at least two hooks 22, 23, and two corresponding latch sockets 31, 32 are used.

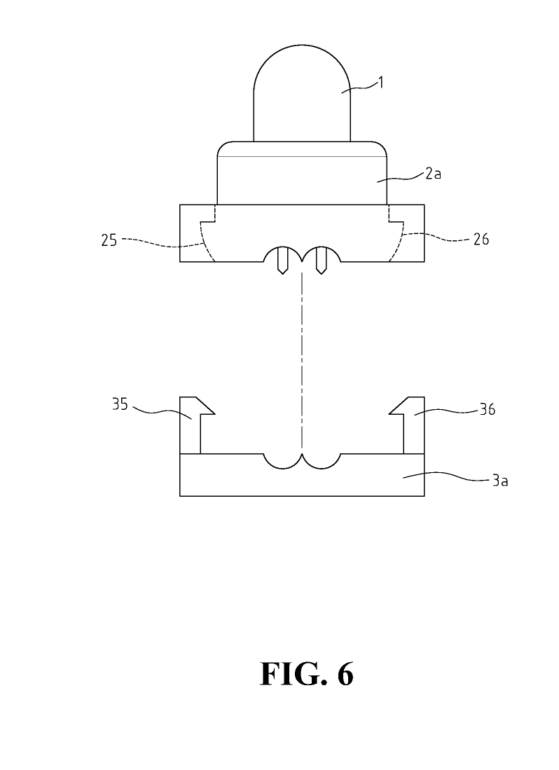

FIG. 6 shows a schematic view of a third embodiment of the present invention. In this embodiment, the shape of base 3a is different. The left side and right side of the top surface of base 3a include a left hook 35 and a right hook 36, respectively. Correspondingly, a left engaging socket 25 and a right engaging socket 26 are formed in the lower part of bulb holder 2a. The shape and the location of left engaging socket 25 and right engaging socket 26 must match those of left hook 35 and right hook 36, accordingly. When assembled, bulb holder 2a and base 3a are engaged together by engaging sockets 25, 26 and hooks 35, 36. Therefore, it is worth noting that the base is not limited to any specific shape, as long as the shape of the base matches the shape of the bulb holder, and includes an engaging structure to engage the bulb holder and the base when assembled to hold the conductive wire in place.

In summary, the light bulb conductive device of the present invention is to form a bulb holder by injection molding on the light bulb so that the light bulb is embedded in and held by the bulb holder. Also, with an additional base to match the bulb holder, the conductive wires can be held in a passage formed between the bulb holder and the base. With the design of conductive needles in the light bulb, the conductive needles can penetrate the plastic shell of the conductive wire and contact the metal conductive wire to form electrical connection. Therefore, the present invention provides more convenience, and is water-proof and less expensive to manufacture.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A light bulb conductive device, comprising:
a light bulb, further comprising a pair of conductive needles with one end connecting to said light bulb and the other end having a sharp tip for penetrating a plastic shell of a conductive wire to contact with conductive metal wire to form electrical connection;
a bulb holder, fixed to the outside of said light bulb, with said pair of conductive needles penetrating said bulb holder with a small segment extending beyond said bulb holder, said bulb holder having a bottom surface formed with a left hook and a right hook extending downward; and
a base engaged with said bulb holder, said base having a top surface formed with a left latch socket and a right latch socket facing the bottom surface of said bulb holder;
wherein said left latch socket has a slanted guiding surface matching a slanted surface of said left hook for receiving and latching said left hook, and said right latch socket has a slanted guiding surface matching a slanted surface of said right hook for receiving and latching said right hook.

2. The device as claimed in claim 1, wherein that said conductive wire is placed between said base and said bulb holder.

3. The device as claimed in claim 2, wherein said light bulb is embedded in said bulb holder, the bottom surface of said bulb holder comprises a holder trench, said conductive needles of said light bulb penetrate said bulb holder and expose a small segment in said holder trench, said base further comprises a base trench and when assembled, said left hook and said right hook are latched into said left latch socket and said right latch socket so that said holder trench and said base trench form a passage for holding said conductive wire.

4. The device as claimed in claim 3, wherein said holder trench is a pair of parallel trenches, and said base trench is also a pair of parallel trenches matching to said holder trench.

5-6. (canceled)

7. The device as claimed in claim 1, wherein said light bulb is an LED.

8. The device as claimed in claim 1, wherein said light bulb is a white tungsten light bulb.

9. (canceled)
